(19) United States
(12) Patent Application Publication
(10) Pub. No.: US 2011/0153882 A1
(43) Pub. Date: Jun. 23, 2011

(54) APPARATUS AND METHOD FOR TRANSFORMING CONTENT

(75) Inventor: Wang Bong LEE, Daejeon (KR)

(73) Assignee: Electronics and Telecommunications Research Institute, Daejeon (KR)

(21) Appl. No.: 12/878,847

(22) Filed: Sep. 9, 2010

(30) Foreign Application Priority Data
Dec. 21, 2009 (KR) 10-2009-0128493

(51) Int. Cl. G06F 13/10

(52) U.S. Cl. 710/65

(57) ABSTRACT

A content transformation apparatus includes an interface unit connected to at least one universal interface, and a process unit to control at least one content received through the interface unit from the at least one universal interface to be transformed to a content corresponding to a format of another universal interface, and to control the transformed content to be transmitted to the other universal interface through the interface unit.

### CROSS-REFERENCE TO RELATED APPLICATION

This application claims the benefit of Korean Patent Application No. 10-2009-0128493, filed on Dec. 21, 2009, in the Korean Intellectual Property Office, the disclosure of which is incorporated herein by reference.

### BACKGROUND

1. Field of the Invention

The present invention relates to an apparatus and method for transforming content flowing from various interfaces.

2. Description of the Related Art

In this information era, with a development of technologies of recognizing, inputting, representing, and outputting information, multimedia technologies are being provided to process a variety of media including sound, diagrams, or video, in addition to text.

Video and sound are mainly defined as multimedia and as such, an amount of information is enormous. Accordingly, it is very difficult for resources to process the information. To process and transmit the information more readily, there is a desire for an exchange technology to provide a high-speed transmission line and various bandwidths, and a technology to transform video and audio signals.

An apparatus of the exchange technology for transforming information is referred to as a transformer. However, it is impossible for a conventional transformer to transform information by extending interfaces that will be changed or added later, using a fixed serial interface and a fixed Ethernet interface, in the same manner as a serial-Ethernet transformer.

Thus, there is a desire for a technology to accommodate an extension to various interfaces that will be changed or added later, using a fixed interface as a standard and/or universal interface, such as a Universal Serial Bus (USB).

### SUMMARY

According to an aspect of the present invention, there is provided a content transformation apparatus including: an interface unit connected to at least one universal interface; and a process unit to control at least one content received through the interface unit from the at least one universal interface to be transformed to a content corresponding to a format of another universal interface, and to control the transformed content to be transmitted to the other universal interface through the interface unit.

According to another aspect of the present invention, there is provided a content transformation apparatus including: a first interface connector connected to at least one first interface, to receive at least one first content; a process unit to control the at least one first content received from the first interface connector to be transformed to at least one second content corresponding to a format of at least one second interface; and a second interface connector connected to the at least one second interface, to transmit the at least one second content to the at least one second interface.

According to another aspect of the present invention, there is provided a content transformation method including: receiving at least one content from at least one interface; determining whether the at least one content is processable; analyzing whether the determined at least one content is copyrighted or encrypted; and transforming the analyzed at least one content.

According to another aspect of the present invention, there is provided a content transformation method including: connecting at least one universal interface to a process unit; and controlling at least one content received from the at least one universal interface to be transformed to a content corresponding to a format of another universal interface, and controlling the transformed content to be transmitted to the other universal interface.

According to another aspect of the present invention, there is provided a content transformation method including: connecting a first interface connector to at least one first interface, to receive at least one first content; controlling the at least one first content received from the at least one first interface to be transformed to at least one second content corresponding to a format of at least one second interface; and connecting a second interface connector to the at least one second interface, to transmit the at least one second content to the at least one second interface.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a content transformation apparatus according to an embodiment of the present invention;

FIG. 2 is a block diagram illustrating a content transformation apparatus according to an embodiment of the present invention, in further detail;

FIG. 3 is a flowchart illustrating a content transformation method according to an embodiment of the present invention;

FIG. 4 is a block diagram illustrating a configuration of a process unit of the content transformation apparatus of FIG. 2;

FIG. 5 is a block diagram illustrating a configuration of a content transformation apparatus according to another embodiment of the present invention;

FIG. 6 is a flowchart illustrating a content transformation method according to another embodiment of the present invention; and

FIG. 7 is a flowchart illustrating a content transformation method according to still another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A content transformation apparatus according to an embodiment of the present invention may transform a content received from an apparatus that generates or stores contents to a content having a different format from the received content, or to a content that supported by an interface of another apparatus.

For example, according to an embodiment of the present invention, there may be provided an apparatus of transforming a video content generated by a camera equipped with a Universal Serial Bus (USB) interface to a content supported by an apparatus with an Ethernet interface.

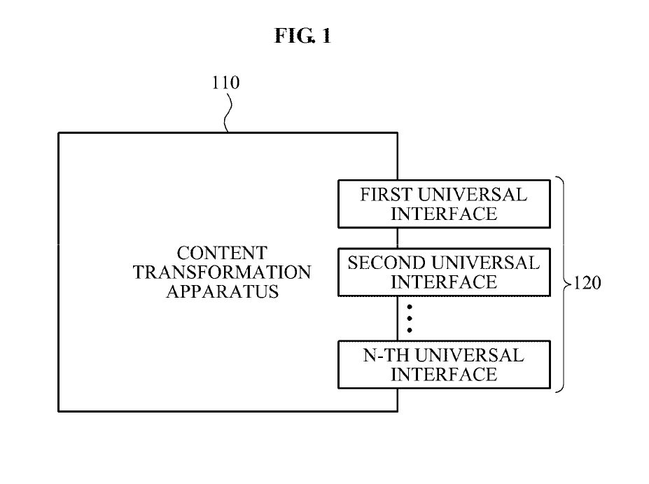

Hereinafter, a content transformation apparatus, and a method of transforming a content using the content transformation apparatus will be further described with reference to FIG. 1.

FIG. 1 is a block diagram illustrating a configuration of a content transformation apparatus 110 according to an embodiment of the present invention.

As shown in FIG. 1, the content transformation apparatus 110 may transform a content received from at least one universal interface among universal interfaces 120, and may transmit the transformed content to another universal interface. Here, the universal interfaces 120 may comprise a first universal interface through an n-th universal interface.

For example, the content transformation apparatus 110 may transform a content received from the first universal interface to a content corresponding to a format of the second universal interface, and may transmit the transformed content to the second universal interface.

According to an embodiment of the present invention, a content may not be limited to a single format, and may be provided in various formats, for example audio information, video information, digital information, or analog information.

A process unit of the content transformation apparatus 110 may function to transform content and to manage other means. Additionally, the content transformation apparatus 110 may further include a storage unit, such as a memory or a disk, if necessary, in addition to the process unit that performs basic functions of an Operating System (OS).

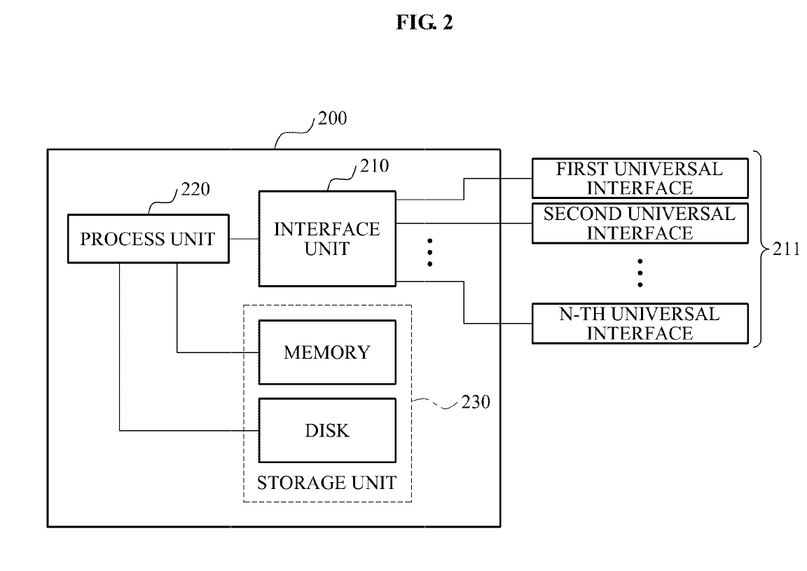

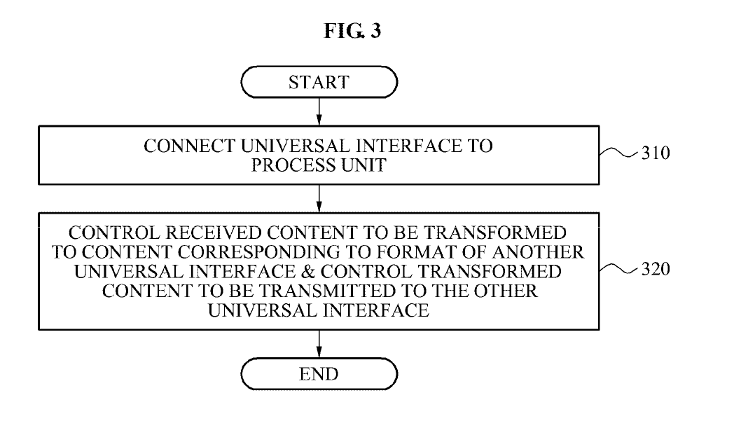

Hereinafter, a configuration of a content transformation apparatus, and a method of transforming contents using the content transformation apparatus will be further described with reference to FIGS. 2 and 3.

FIG. 2 is a block diagram illustrating a content transformation apparatus 200 according to an embodiment of the present invention, in further detail, and FIG. 3 is a flowchart illustrating a content transformation method according to an embodiment of the present invention.

As shown in FIG. 2, the content transformation apparatus 200 includes an interface unit 210 connected to at least one universal interface among universal interfaces 211, and a process unit 220 functioning to transform and manage contents.

The content transformation apparatus 200 may connect the interface unit 210 to at least one universal interface among the universal interfaces 211 in operation 310, to receive a content from the universal interface connected to the interface unit 210, to immediately transform the received content through the process unit 220, and to provide the transformed content to another universal interface.

Specifically, the process unit 220 of the content transformation apparatus 200 may control at least one content received through the interface unit 210 from the at least one universal interface to be transformed to a content corresponding to a format of another universal interface, and may control the transformed content to be transmitted to the other universal interface through the interface unit 210 in operation 320.

The process unit 220 may include a serial device to manage a content processed by the interface unit 210.

Additionally, the content transformation apparatus 200 may further include a storage unit 230 to process information regarding an OS of the process unit 220, and the at least one content received from the at least one universal interface 211. The storage unit 230 may be designed to include a memory or a disk.

Here, a function of the storage unit 230 of the content transformation apparatus 200 may be restricted based on the copyright law. For example, the process unit 220 may control the received content and the transformed content to be transmitted to the other universal interface 211, not to be stored in the storage unit 230.

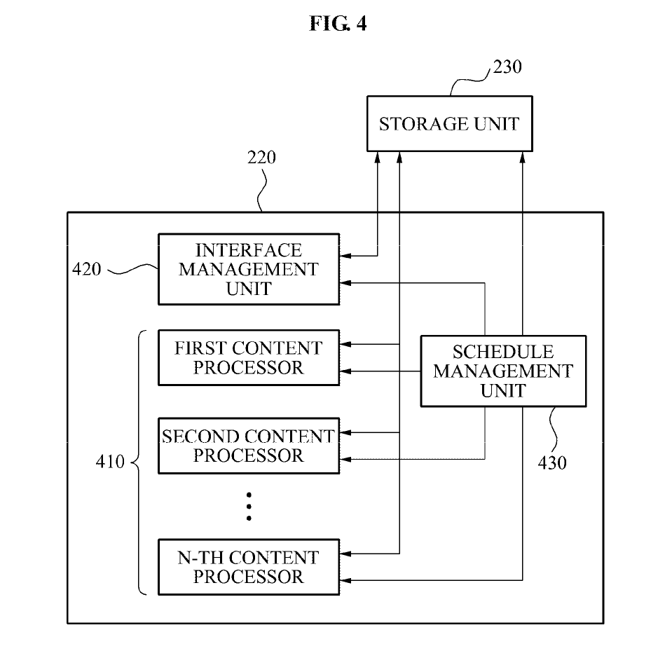

FIG. 4 is a block diagram illustrating a configuration of the process unit 220 of the content transformation apparatus 200.

Referring to FIG. 4, the process unit 220 may transform a content received from at least one universal interface among the universal interfaces 211 to a content corresponding to a format of another universal interface, using at least one content processor among content processors 410.

Additionally, the process unit 220 may dynamically delete or generate at least one content processor among content processors 410.

The process unit 220 may be operated by various OSs, that is, may manage the content processors 410 based on various OSs. Here, the various OSs may include, for example, a commercial VxWorks OS, or an open source OS such as Linux and BSD.

When the process unit 220 is equipped with the OS, an interface enabling processing of a variety of contents may be connected, and simultaneously, a software module may be configured, based on characteristics of the OS. For example, the process unit 220 may operate the content transformation apparatus 200 using characteristics of an OS and a driver of Linux, or using characteristics of an OS and a driver of BSD.

Here, various OSs may enable a Dynamic Loadable Driver to dynamically delete or generate at least one content processor, so that a high-speed content processor 410 may be generated.

Additionally, a multi-core Central Processing Unit (CPU) may be used to achieve a high-speed process, and an individual core of a multi-core may be used for a single content processor 410. The content processors 410 may the at least one content, and may add another content to the at least one content.

The process unit 220 may include an interface management unit 420 to match the universal interfaces 211.

The process unit 220 may further include a schedule management unit 430 to manage a schedule. The schedule may be used to set an order of transformation of contents received from the universal interfaces 211, or to transmit transformed contents.

The content transformed by the process unit 220 may be stored in the storage unit 230, as described above. Conversely, a content restricted due to a copyright may be set so as to be not stored in the storage unit 230.

As described above, the content transformation apparatus 200 may be used as an apparatus of connecting different interfaces, to immediately transform a content received from an interface to another content having a format of another interface, and to provide the transformed content.

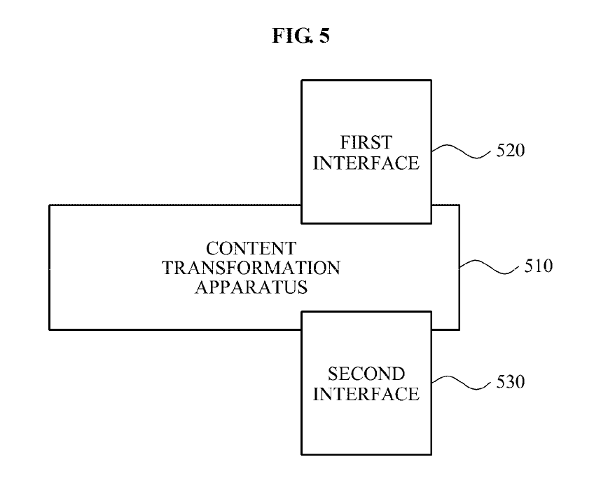

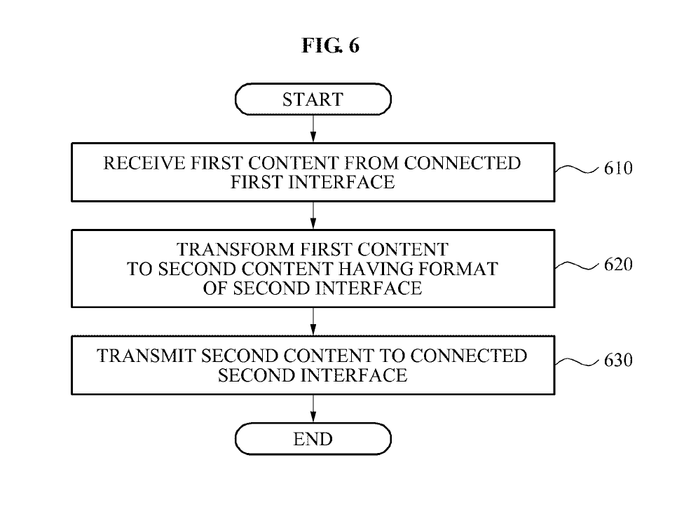

FIG. 5 is a block diagram illustrating a configuration of a content transformation apparatus 510 according to another embodiment of the present invention, and FIG. 6 is a flowchart illustrating a content transformation method according to another embodiment of the present invention.

Referring to FIG. 5, the content transformation apparatus 510 may transform a content received from a first interface 520 to a content having a format of a second interface 530, and may transmit the transformed content to the second interface 530.

Referring to FIG. 6, in operation 610, the content transformation apparatus 510 may be connected to the first interface 520 through a first interface connector, and may receive at least one first content.

In operation 620, the content transformation apparatus 510 may control a process unit to transform the at least one first content received from the first interface 520 to at least one second content having the format of the second interface 530.

For example, the content transformation apparatus 510 may be implemented as a protocol processing apparatus. In this example, the first interface 520 and the second interface 530 may be implemented as a heterogeneous interface, for example a USB interface, and a Wireless Broadband (WiBro) interface.

As another example, the content transformation apparatus 510 may be implemented as a camera. In this example, the camera may be equipped with an interface, for example, a USB interface, and an Institute of Electrical and Electronics Engineers (IEEE) 1394 interface.

In operation 630, the content transformation apparatus 510 may be connected to the second interface 530, and may transmit the at least one second content to the second interface 530.

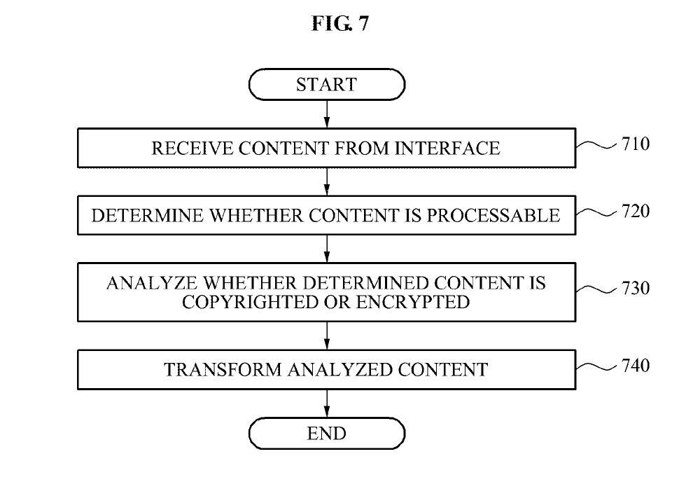

Hereinafter, another content transformation method will be described with reference to FIG. 7.

FIG. 7 is a flowchart illustrating a content transformation method according to still another embodiment of the present invention.

Referring to FIG. 7, in operation 710, a content transformation apparatus according to an embodiment of the present invention may receive at least one content from at least one interface.

In operation 720, the content transformation apparatus may determine whether the at least one content is processable.

In operation 730, the content transformation apparatus may analyze whether the determined at least one content is copyrighted or encrypted.

In operation 740, the content transformation apparatus may transform the analyzed at least one content.

As described above, a content transformation apparatus according to embodiments of the present invention may use a fixed interface as a standard and/or universal interface, such as a USB interface, and thus, it is possible to extend to various interfaces that will be adjusted later.

Accordingly, the content transformation apparatus may be used to transform a content received from an apparatus equipped with an interface to a content having a format of another interface, and to transmit the transformed content to an apparatus with the other interface.

For example, the content transformation apparatus may be used as an apparatus of transmitting a content received from a digital camera equipped with a universal interface to another apparatus connected to the Internet, as an apparatus of transmitting a content received from an apparatus for medical use with a universal interface to another apparatus connected to the Internet, and as an apparatus of transmitting digital or analog video contents to another apparatus connected to the Internet.

As another example, the content transformation apparatus may be utilized as an apparatus of processing or not processing information regarding a wired and/or wireless Ethernet interface device with a universal interface, and transmitting the information to another wired and/or wireless Ethernet interface device.

Additionally, when developing a product equipped with an interface, the content transformation apparatus may be utilized to perform a parallel development on a converter and an interface unit as independent devices using a universal interface as an intermediate connecter, instead of a separate interface being directly developed.

Furthermore, the content transformation apparatus may be used to enable a communication between objects having various interfaces.

Thus, according to the embodiments of the present invention, it is possible to accommodate an expansion to various interfaces that will be adjusted or added later by using a fixed interface as a standard and/or universal interface such as a USB interface.

Additionally, according to the embodiments of the present invention, it is possible to provide an apparatus of transforming a flowing content according to a specific purpose and transmitting the transformed content to a specific interface, so that various contents or various protocols may be transformed to targets for the specific purpose.

Furthermore, according to the embodiments of the present invention, it is possible to transform protocols and content between heterogeneous networks.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A content transformation apparatus, comprising:
an interface unit connected to at least one universal interface; and
a process unit to control at least one content received through the interface unit from the at least one universal interface to be transformed to a content corresponding to a format of another universal interface, and to control the transformed content to be transmitted to the other universal interface through the interface unit.

2. The content transformation apparatus of claim 1, wherein each of the contents comprises at least one of audio information, video information, digital information, and analog information.

3. The content transformation apparatus of claim 1, further comprising:
a storage unit to process information regarding an Operating System (OS) of the process unit, and the at least one content received from the at least one universal interface.

4. The content transformation apparatus of claim 3, wherein the process unit controls the at least one content and the transformed content to be transmitted to the other universal interface, not to be stored in the storage unit.

5. The content transformation apparatus of claim 1, wherein the process unit comprises at least one content processor to transform the at least one content to a content corresponding to a format of another universal interface.

6. The content transformation apparatus of claim 5, wherein the process unit dynamically deletes or generates the at least one content processor.

7. The content transformation apparatus of claim 6, wherein the process unit is operated by at least one OS, and manages the at least one content processor corresponding to the at least one OS.

8. The content transformation apparatus of claim 5, wherein the process unit further comprises an interface management unit to match the at least one universal interface.

9. The content transformation apparatus of claim 5, wherein the at least one content processor transforms the at least one content, or adds another content to the at least one content.

10. A content transformation apparatus, comprising:
a first interface connector connected to at least one first interface, to receive at least one first content;
a process unit to control the at least one first content received from the first interface connector to be transformed to at least one second content corresponding to a format of at least one second interface; and
a second interface connector connected to the at least one second interface, to transmit the at least one second content to the at least one second interface.

11. A content transformation method, comprising:
receiving at least one content from at least one interface;
determining whether the at least one content is processable;
analyzing whether the determined at least one content is copyrighted or encrypted; and
transforming the analyzed at least one content.

12. A content transformation method, comprising:
connecting at least one universal interface to a process unit; and
controlling at least one content received from the at least one universal interface to be transformed to a content corresponding to a format of another universal interface, and controlling the transformed content to be transmitted to the other universal interface.

13. The content transformation method of claim 12, further comprising:
processing information regarding an OS of a process unit, and the at least one content received from the at least one universal interface.

14. The content transformation method of claim 13, wherein the controlling comprises controlling the at least one content and the transformed content to be transmitted to the other universal interface, not to be stored.

15. The content transformation method of claim 12, further comprising:
dynamically deleting or generating at least one content processor, the at least one content processor processing a transformation of the at least one content.

16. The content transformation method of claim 15, further comprising:
managing the at least one content processor corresponding to at least one OS,
wherein the controlling is performed by the at least one OS.

17. The content transformation method of claim 12, further comprising:
matching the at least one universal interface.

18. The content transformation method of claim 12, wherein the controlling comprises transforming the at least one content, or adding another content to the at least one content.
